(19) United States
(12) Patent Application Publication
(10) Pub. No.: US 2007/0049222 A1
(43) Pub. Date: Mar. 1, 2007

(54) Front end module

(75) Inventor: Cho Jeong Hoon, Gyeonggi-do (KR)

Correspondence Address: BIRCH STEWART KOLASCH & BIRCH, PO BOX 747, FALLS CHURCH, VA, 22040-0747, US

(73) Assignee: LG INNOTEK CO., LTD

(21) Appl. No.: 11/510,597

(22) Filed: Aug. 28, 2006

(30) Foreign Application Priority Data
Aug. 29, 2005 (KR) 10-2005-0079351

(51) Int. Cl. H04B 7/08; H04B 1/06

(52) U.S. Cl. 455/132; 455/272

(57) ABSTRACT

A front end module is provided. The front end module includes: a first LC tank passing a first signal and a second signal and cutting off a third signal in signals received from an antenna; a diplexer connected to an output terminal of the first LC tank to transfer the first signal and the second signal into a first signal processing unit and a second signal processing unit, respectively; and a second LC tank connected in parallel to the first LC tank to cut off the first signal and transfer the third signal into a third signal processing unit.

### BACKGROUND OF THE INVENTION

1. Field of the Invention

The present invention relates to a front end module.

2. Description of the Related Art

A related art dual band mobile communication device includes a diplexer capable of receiving two respectively different frequencies (1900 MHz band (PCS) and 800 MHz (DCN))) through one antenna.

The latest dual band mobile communication device further includes a global position system (GPS) function, and thus requires a triple band mobile device. The triple band mobile communication device processes three frequency bands (PCS: 1850 to 1990 MHz, GPS: 1574.42 to 1576.42 MHz, and DCN: 824 to 894 MHz).

That is, current mobile communication device basically are equipped with a GPS function.

FIG. 1 is a block diagram of components in a related art triple band mobile communication device 10.

Referring to FIG. 1, the related art triple band mobile communication device 10 includes an active switch 11, a DCN signal processing unit 12, a PCS signal processing unit 13, a GPS signal processing unit 14, and controller 15.

The active switch 11 performing a triplexer function receives respective signals of a DCN band, a PCS band, and a GPS bans through an antenna, and transmits signals of the DCN band and the PCS band.

The DCN signal processing unit 12 processes the signal of the DCN band separated from the active switch 11 as a call signal.

Moreover, the PCS signal processing unit 13 processes the signal of the PCS band separated from the active switch 11 as a call signal, and the GPS signal processing unit 14 demodulates the signal of the GPS band to generate three-dimensional ground location determination information.

The controller 15 outputs the signal received from the DCN signal processing unit 12 or the PCS signal processing unit 13 as a voice, transmits the transmitted signal to the DCN processing unit 12 or the PCS signal processing unit 13, or processes the inputted ground location determination information from the GPS signal processing unit 14.

At this point, the antenna includes a dual band antenna and a GPS antenna. The dual band antenna transmits and receives signals in synchronization with the DCN and PCS signals. The triple band using only one antenna can be realized through a triplexer, which is not a single pole three throw (SP3T).

A related art triplexer can be realized as one chip using more than 10 lumped elements. However, problems can occur as follows.

First, as the number of receiving modes increase, a frequency interval between the receiving modes becomes closer. Thus, it is difficult to manufacture a filter for simultaneously filtering various signals. Especially, when a frequency interval in the GPS mode and the PCS mode becomes 280 MHz, it is very hard to manufacture a triplexer to separate signals, and also many lumped elements are necessary.

Second, since many lumped elements are necessary, it is difficult to miniaturize the product.

Third, when the triplexer is realized using the many lumped elements, the insertion loss occurs due to a high frequency, and also the ripples in a pass band increase according to the increase of the frequency band.

Fourth, to improve the receive sensitivity of DCN, PCS, and GPS bands, a low insertion loss needs to be realized. Additionally, an additional circuit such as a low noise amplifier (LNA) is required for a low receive sensitivity generated by the high insertion loss of a GSP terminal.

Accordingly, it is necessary to improve a structure of the related art triplexer to realize a high quality call service and miniaturization.

### SUMMARY OF THE INVENTION

Accordingly, the present invention is related to a front end module that substantially obviates one or more problems due to limitations and disadvantages of the related art.

The present invention provides a front end module having the minimized number of lump elements.

The present invention provides a front end module preventing a leakage current to the maximum between adjacent circuits such that a band signal in each frequency maintains a stable signal and is separated without mutual interference.

The present invention provides a miniaturized front end module.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

In an aspect of the present invention, there is provided a front end module including: a first LC tank passing a first signal and a second signal and cutting off a third signal in signals received from an antenna; a diplexer connected to an output terminal of the first LC tank to transfer the first signal and the second signal to a first signal processing unit and a second signal processing unit, respectively; and a second LC tank connected in parallel to the first LC tank to cut off the first signal and transfer the third signal into a third signal processing unit.

In another aspect of the present invention, there is provided a front end module including: a first LC tank passing a first signal and a second signal and cutting off a third signal in signals received from an antenna; a diplexer having a filter unit connected to an output terminal of the first LC tank to transfer the first signal and the second signal to a first signal processing unit and a second signal processing unit, respectively; and a phase shifter and a band pass filter connected in parallel to the first LC tank to cut off the second signal and transfer the third signal into a third signal processing unit.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of components in a related art triple band mobile communication device;

FIG. 2 is a circuit diagram of components in a front end module according to an embodiment of the present invention;

FIG. 3 is a smith chart of an input impedance characteristic in a band pass filter according to an embodiment of the present invention;

FIG. 4 is a view of a circuit configuration in a first LC tank according to an embodiment of the present invention;

FIG. 5 is a view of a circuit configuration in a second LC tank according to an embodiment of the present invention; and

FIG. 6 is a view of a diplexer according to another embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

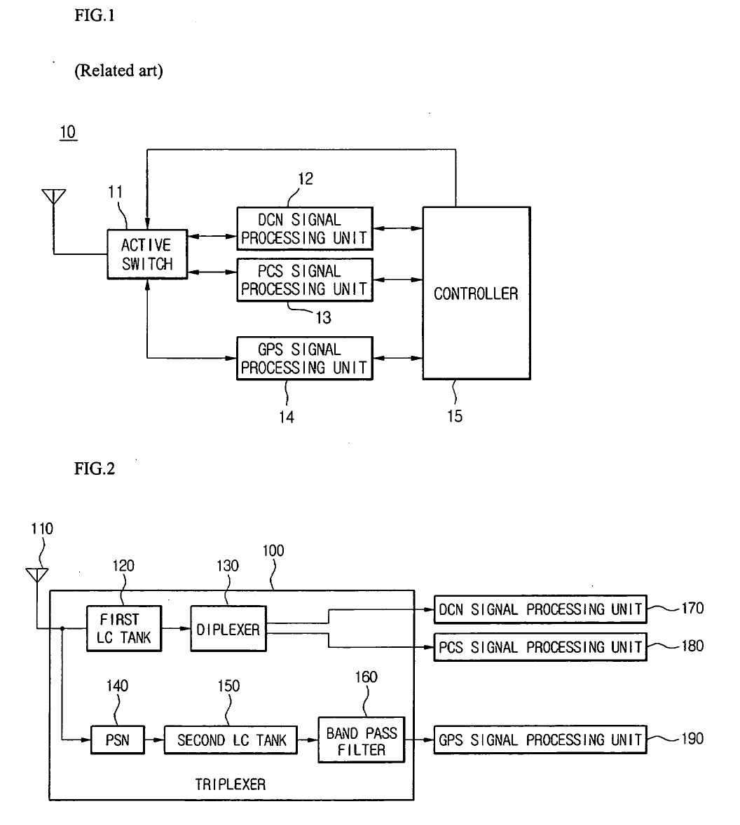

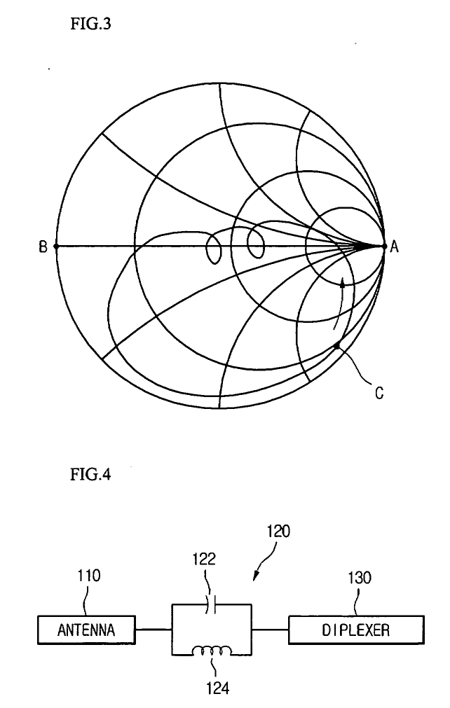

FIG. 2 is a circuit diagram of components in a front end module according to an embodiment of the present invention.

Referring to FIG. 2, a triplexer 100 includes a first LC tank 120, a diplexer 130, a phase shift network (PSN) 140, a second LC tank 150, and a band pass filter 160.

An input terminal of the first LC tank 120 is connected to an antennal 110 and an output terminal of the first LC tank 120 is connected to the diplexer 130. An output terminal of the diplexer 130 is connected to a DCN signal processing unit 170 and a PCS signal processing unit 180.

An output terminal of the band pass filter 160 is connected to a GPS signal processing unit 190.

The triplexer 100 of the present invention transmits and receives frequency signals of a triple band, that is, a DCN signal, a GPS signal, and a PCS signal, through the antenna 110.

First, the first LC tank 120 is connected to the diplexer 130, cuts off a GPS signal in the received signal from the antenna 110, and passes a DCN signal and a PCS signal to be transferred into the diplexer 130.

The diplexer 130 includes a high pass filter (HPF) and a low pass filter (LPF), which are made of integrated passive devices. Additionally, the diplexer 130 separates an entire signal mixed with various frequency signals into two frequency bands where frequency spectrums don't overlap by using frequency division multiplexing.

The two output terminals of the diplexer 130 are connected to the DCN signal processing unit 170 and the PCS signal processing unit 180, respectively. The HPF passes a PCS signal of a relatively high band in signals inputted from the first LC tank 120. The LPF passes a DCN signal of a relatively low band in signals inputted from the first LC tank 120.

When the inputted signals from the first LC tank 120 are separated, the diplexer 130 transfers the separated DCN signal into the DCN signal processing unit 170, and the DCN signal processing unit 170 processes the DCN signal to generate multimedia data.

Additionally, the diplexer 130 transfers the separated PCS signal into the PCS signal processing unit 180, and the PCS signal processing unit 180 processes the PCS signal to generate multimedia data.

On the other hand, the diplexer 130 can be realized using a single pole double throw (SPDT) switch. The SPDT switch is a kind of an integrated circuit (IC) switch, and can operate using a bias voltage. Additionally, the SPDT switch operates up to 3 GHz in DC using two straight polarity control voltages. The control voltage is very low such that it is possible to operate the SPDT switch at 2.4 V.

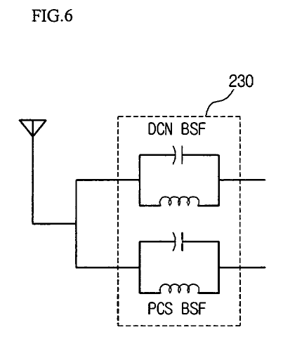

FIG. 6 is a view of a diplexer according to another embodiment of the present invention.

A diplexer 230 includes a DCN band stop filter (BSF) and a PCS BSF, which are connected in parallel. The DCN BSF includes an LC circuit to cut off a DCN signal, and the PCS BSF includes an LC circuit to cut off a PCS signal.

Referring to FIG. 6, the diplexer 230 can be embodied using only four lumped elements because of the DCN BSF and the PCS BSF. Therefore, the smaller number of lumped elements can be used to form the diplexer 230 compared to the diplexer 130 of FIG. 2 including the HPF and the LPF.

Referring to FIG. 2, the first LC tank 120 is connected in parallel to the PSN 140, and the PSN 140 is connected in series to the second LC tank 150 and the band pass filter 160.

A portion of the DCN signal and PCS signal is not completely cut off in a path of the GPS signal, and thus can leak into the GPS signal processing unit 190. Therefore, the DCN signal and the PCS signal inputted into the PSN 140 and the second LC tank 150 need to be filtered such that the DCN signal and the PCS signal are inputted into the DCN signal processing unit 170 and the PCS signal processing unit 180 without leakage, respectively.

For this, when the PCS signal is inputted into the PSN 140, the band pass filter 160 operates as an open circuit.

On the other hand, according to another embodiment, the second LC tank 150 can be disposed between the band pass filter 160 and the GPS signal processing unit 190. That is, the band pass filter 160 is disposed previous to the second LC tank 150.

According to another embodiment, the second LC tank 150 can be connected in parallel to the first LC tank 120. The PSN 140 and the band pass filter 160 can be disposed between the second LC tank 150 and the GPS signal processing unit 190. That is, the second LC tank 150 is disposed previous to the PSN 140 and the band pass filter 160.

FIG. 3 is a smith chart of an input impedance characteristic in a band pass filter according to an embodiment of the present invention.

Referring to FIG. 3, when load impedance coordinates of a signal are formed on point A in the smith chart, a circuit operates as an open circuit in an aspect of a signal. When load impedance coordinates of a signal are formed on point B in the smith chart, a circuit operates as a short circuit in an aspect of a signal.

In the PCS band, input impedance coordinates of the band pass filter 160 represents a point C. Moreover, the load impedance coordinates C of the PCS signal is moved to an opening point A of the band pass filter 160 through the PSN 140.

Accordingly, since the band pass filter 160 operates as an open circuit in an aspect of a PCS signal, the PCS signal does not flow into the band pass filter 160, but flows into the first LC tank 120 without a signal loss.

Additionally, the second LC tank 150 performs a cut off function to prevent the DCN signal in a path of the GPS signal from flowing into the GPS signal processing terminal 190.

As an impedance matching is performed in the PSN 140 to move the impedance coordinates of the PCS signal into an opening point, the second LC tank 150 operates as an open circuit in the DCN band to prevent the DCN signal from leaking into the GPS signal processing unit 190.

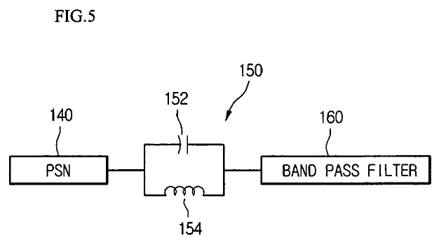

FIG. 4 is a view of a circuit configuration in a first LC tank according to an embodiment of the present invention. FIG. 5 is a view of a circuit configuration in a second LC tank according to an embodiment of the present invention.

Referring to FIGS. 4 and 5, the first and second LC tanks 120 and 150 includes inductors 124 and 154 and capacitors 122 and 152, which are connected in parallel. The first LC tank 120 prevents the GPS signal inputted from the antenna 110 from flowing into the diplexer 130.

The second LC tank 150 prevents the DCN signal inputted from the antenna 110 from flowing into the GPS signal processing unit 190.

Accordingly, the second LC tank 150 operates as an open circuit in an aspect of the DCN signal. Therefore, most of the DCN signal flow into the diplexer 130 without the current loss, and most of the GPS signal flow into the GPS signal processing unit 190 without the current loss.

The GPS signal passing through the PSN 140, the second LC tank 150 and the band pass filter 160 flows into the GPS signal processing unit 190. The GPS signal processing unit 190 decodes the GPS signal to generate location information.

The band pass filter 160 can include a GPS surface acoustic wave (SAW) filter.

The GPS SAW filter is connected to a terminal of the antenna 110 to minimize the insertion loss in a path of the GPS signal. Additionally, since the GPS SAW filter has a high impedance in the PCS band, it is possible in itself to prevent the PCS signal received from the antenna 110 from flowing into the GPS signal processing unit 190.

According to a front end module of the present invention, since a triplexer can be embodied using the minimum number of lumped elements, miniaturization can be achieved. Since a leakage current between adjacent circuits can be effectively cut off, transmitting and receiving quality increases.

Moreover, a front end module having a low insertion loss in the GPS band can be embodied.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A front end module comprising:
a first LC tank passing a first signal and a second signal and cutting off a third signal in signals received from an antenna;
a diplexer connected to an output terminal of the first LC tank to transfer the first signal and the second signal to a first signal processing unit and a second signal processing unit, respectively; and
a second LC tank connected in parallel to the first LC tank to cut off the first signal and transfer the third signal into a third signal processing unit.

2. The front end module according to claim 1, further comprising a phase shifter and a band pass filter connected between the first LC tank and the second LC tank.

3. The front end module according to claim 2, wherein the phase shifter comprises a PSN (phase shift network).

4. The front end module according to claim 1, wherein the first LC tank comprises an inductor and a capacitor connected in parallel.

5. The front end module according to claim 1, wherein the second LC tank comprises an inductor and a capacitor connected in parallel.

6. The front end module according to claim 2, wherein the band pass filter comprises a SAW (surface acoustic wave) filter.

7. The front end module according to claim 1, wherein the diplexer includes a SPDT (single pole double throw) switch.

8. The front end module according to claim 1, wherein the diplexer includes a high band filter and a low band filter.

9. The front end module according to claim 1, wherein the diplexer comprises a first band stop filter passing the first signal and a second band stop filter passing the second signal.

10. The front end module according to claim 1, wherein the first signal, the second signal, and the third signal represent a DCN signal, a PCS signal, and a GPS signal, respectively.

11. The front end module according to claim 1, further comprising a phase shifter and a band pass filter connected between the first LC tank and the third signal processing unit.

12. The front end module according to claim 11, wherein the phase shifter is connected between the first LC tank and the second LC tank, and the band pass filter is connected between the second LC tank and the third signal processing unit.

13. The front end module according to claim 11, wherein the phase shifter and the band pass filter are connected between the second LC tank and the third signal processing unit.

14. A front end module comprising:
a first LC tank passing a first signal and a second signal and cutting off a third signal in signals received from an antenna;
a diplexer having a filter unit connected to an output terminal of the first LC tank to transfer the first signal and the second signal to a first signal processing unit and a second signal processing unit, respectively; and
a phase shifter and a band pass filter connected in parallel to the first LC tank to cut off the second signal and transfer the third signal into a third signal processing unit.

15. The front end module according to claim 14, further comprising a second LC tank connected between the first LC tank and the third signal processing unit to prevent the first signal from being transferred into the third signal processing unit.

16. The front end module according to claim 14, wherein the phase shifter comprises a PSN.

17. The front end module according to claim 14, wherein the first LC tank comprises an inductor and a capacitor connected in parallel.

18. The front end module according to claim 15, wherein the second LC tank comprises an inductor and a capacitor connected in parallel.

19. The front end module according to claim 14, wherein the filter unit comprises a low band filter and a high band filter.

20. The front end module according to claim 14, wherein the filter comprises a first band stop filter passing the first signal and a second band stop filter passing the second signal.
